(19) United States
(12) Patent Application Publication
(10) Pub. No.: US 2017/0031286 A1
(43) Pub. Date: Feb. 2, 2017

(54) IMAGE HEATING APPARATUS AND HEATER USED IN SAME

(71) Applicant: CANON KABUSHIKI KAISHA, Tokyo (JP)

(72) Inventors: Haruki Ishibashi, Numazu-shi (JP); Masato Hisano, Yokohama-shi (JP); Kazushi Nishikata, Tokyo (JP); Fumiki Inui, Mishima-shi (JP); Kazuhide Kudo, Numazu-shi (JP); Yoshihiro Matsuo, Suntou-gun (JP)

(21) Appl. No.: 15/220,134

(22) Filed: Jul. 26, 2016

(30) Foreign Application Priority Data
Jul. 31, 2015 (JP) 2015-152145

(51) Int. Cl. H05B 3/00

(52) U.S. Cl. CPC G03G 15/2057

(57) ABSTRACT

A heater of the present disclosure includes an insulating substrate, a heating element formed on the substrate, an electrode connected to the heating element, and an insulating layer covering the heating element. In the heater, in a direction orthogonal to a surface of the substrate, a surface of the electrode is protruded with respect to a surface of the insulating layer.

### BACKGROUND OF THE INVENTION

Field of the Invention

The present disclosure relates to an image heating apparatus, such as a fixing device mounted in an image forming apparatus employing an electrophotographic recording system, such as a copier or a printer, or a glossing device that improves a gloss of a toner image by reheating a fixed toner image on a recording material. Furthermore, the present disclosure relates to a heater that is used in the image heating apparatus.

Description of the Related Art

In a heater used in an image heating apparatus, there is a ceramic heater in which a heat generating resistor (hereinafter, referred to as a heating element) is formed on a ceramic substrate.

Japanese Patent Laid-Open No. 2003-168542 discloses a configuration in which conductors and a heating element on a ceramic substrate are covered by an insulator (hereinafter, referred to as an insulating layer) formed of glass or the like, and in which power supply connectors are connected to electrodes that are not covered by the insulator.

FIG. 7A is a plan view of a heater of a comparative example, and FIG. 7B is a cross-sectional view taken along line VIIB-VIIB (an enlarged view of an area W) in FIG. 7A. In a heater 30, a heating element 31 and conductors 33 are formed on a substrate 35. Furthermore, electrodes 32 connected on the conductors 33 are formed. An insulating layer 34 covers a portion of each electrode 32, the heating element 31, and the conductors 33. Electrical contact members 36 provided in a power supply connector comes in contact with the electrodes 32. Since the insulating layer 34 has to cover the heating element 31 and the conductors 33, a height H1 from the substrate 35 to a surface of the insulating layer 34 is larger than a height H2 from the substrate 35 to surfaces of the electrodes 32.

As described above, the positions of the surfaces of the electrodes 32 are lower than the position of the surface of the insulating layer 34. Accordingly, in order to abut the electrical contact members 36 to the electrodes 32 with a predetermined contact pressure, the sizes of the electrical contact members 36 need to be sizes that can be accommodated inside the areas of the electrodes 32 such that the electrical contact members 36 do not come in contact with the insulating layer 34. However, there are limits to the extent to which the electrical contact members 36 can be reduced in size, to the extent to which the components can be increased in accuracy, and to the extent to which the fitting accuracy with respect to the heater can be increased, for example. Accordingly, in order to reliably connect the electrical contact members 36 to the electrodes 32, areas with certain sizes need to be allocated to the electrodes 32, making size reduction of the heater 30 difficult.

### SUMMARY OF THE INVENTION

The present disclosure overcomes the above problem and provides an image heating apparatus and a heater used in the image heating apparatus, which reduces the areas of the electrodes, the size of the heater, and cost.

In an aspect of the present disclosure, a heater used in an image heating apparatus that heats an image formed on a recording material includes an insulating substrate, a heating element formed on the substrate, an electrode connected to the heating element, an electrical contact member that supplies electric power to the heating element being connected to the electrode, and an insulating layer covering the heating element. In the heater, in a direction orthogonal to a surface of the substrate, a surface of the electrode is protruded with respect to a surface of the insulating layer.

In another aspect of the present disclosure, an image heating apparatus that heats an image formed on a recording material includes a heater, in which the heater includes an insulating substrate, a heating element formed on the substrate, an electrode connected to the heating element, an electrical contact member that supplies electric power to the heating element being connected to the electrode, and an insulating layer covering the heating element. In the image heating apparatus, in a direction orthogonal to a surface of the substrate, a surface of the electrode is protruded with respect to a surface of the insulating layer.

In another aspect of the present disclosure, a heater used in an image heating apparatus that heats an image formed on a recording material includes an insulating substrate, a heating element formed on the substrate, an electrode connected to the heating element, an electrical contact member that supplies electric power to the heating element being connected to the electrode, and an insulating layer covering the heating element. In the heater, in the longitudinal direction of the heater, the electrode is provided within an area where the heating element is provided, and in a direction orthogonal to a surface of the substrate, a surface of the electrode is flush with a surface of the insulating layer or is protruded with respect to the surface of the insulating layer.

In another aspect of the present disclosure, an image heating apparatus that heats an image formed on a recording material includes a heater, in which the heater includes an insulating substrate, a heating element formed on the substrate, an electrode connected to the heating element, an electrical contact member that supplies electric power to the heating element being connected to the electrode, and an insulating layer covering the heating element. In the image heating apparatus, in the longitudinal direction of the heater, the electrode is provided within an area where the heating element is provided, and in a direction orthogonal to a surface of the substrate, a surface of the electrode is flush with a surface of the insulating layer or is protruded with respect to the surface of the insulating layer.

Further features of the present invention will become apparent from the following description of exemplary embodiments with reference to the attached drawings.

### BRIEF DESCRIPTION OF THE DRAWINGS

FIG. 1 is a cross-sectional view of a fixing apparatus.

FIGS. 2A and 2B are block diagrams of a heater of a first exemplary embodiment.

FIGS. 3A to 3C are diagrams illustrating a state in which electrical contact members are connected to the heater of the first exemplary embodiment.

FIGS. 4A and 4B are diagrams illustrating modification of the electrode.

FIGS. 5A to 5C are block diagrams of a heater of a second exemplary embodiment.

FIG. 6 is a diagram of a heater driving circuit of the second exemplary embodiment.

FIGS. 7A and 7B are block diagrams of a heater of a comparative example.

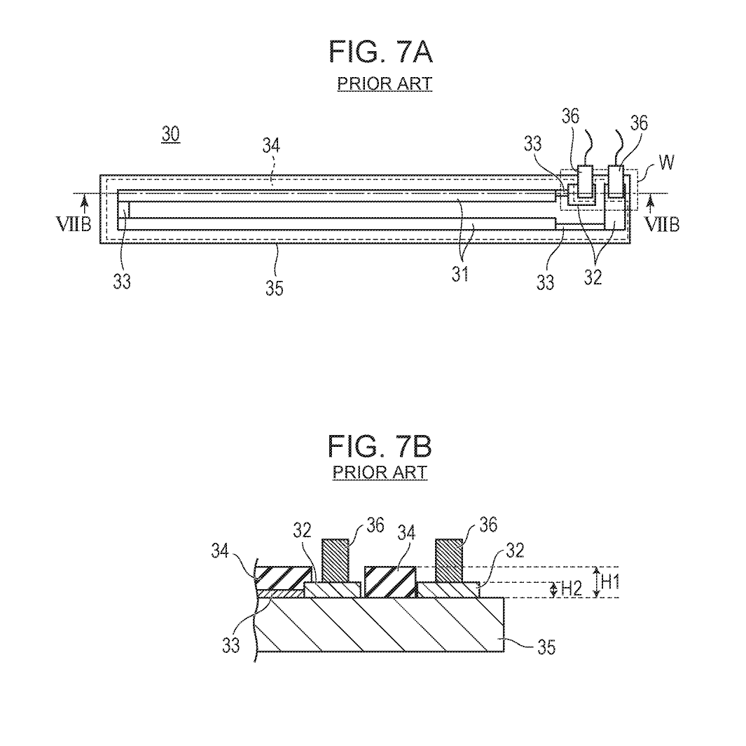

### DESCRIPTION OF THE EMBODIMENTS

### First Exemplary Embodiment

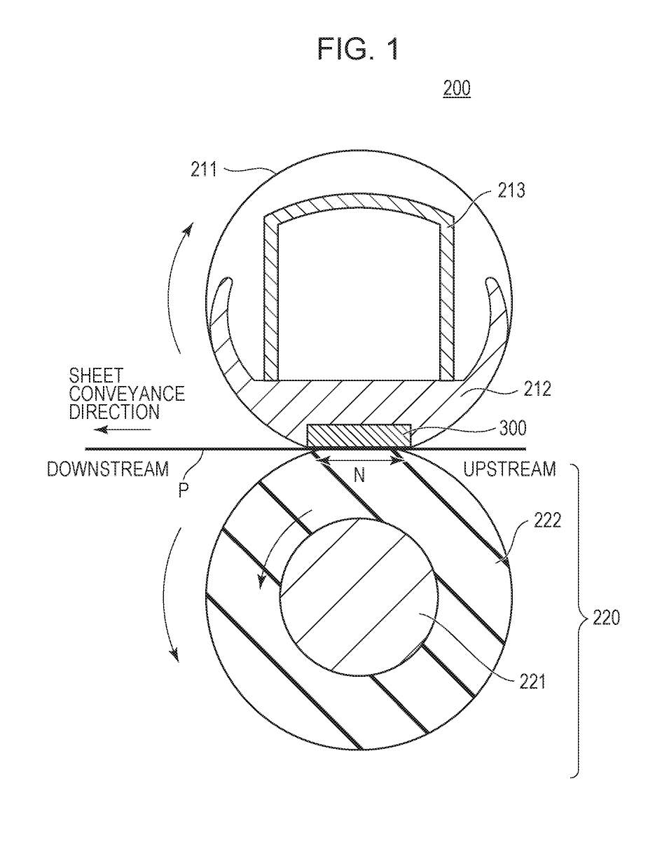

FIG. 1 is a cross-sectional view of a fixing apparatus 200. The fixing apparatus 200 includes a cylindrical film 211, a heater 300 that is in contact with an inner surface of the film 211, and a pressure roller (a nip portion formation member) 220 that forms a fixing nip portion N together with the heater 300 with the film 211 in between. The material of the base layer of the film 211 is a heat resistant resin, such as polyimide, or is metal, such as stainless steel. The pressure roller 220 includes a metal core 221 formed of a material such as iron or aluminum, and an elastic layer 222 formed of a material such as silicone rubber. The heater 300 is held by a holding member 212 made of heat resistant resin. The holding member 212 is compressed towards the pressure roller 220 with a spring or the like (not shown) through a stay 213. By receiving motive power from a motor (not shown), the pressure roller 220 rotates in an arrow direction. The film 211 is rotated by following the rotation of the pressure roller 220. A fixing process is performed on a recording material P, on which an unfixed toner image has been formed, by heating the recording material P that is pinched and conveyed by the fixing nip portion N.

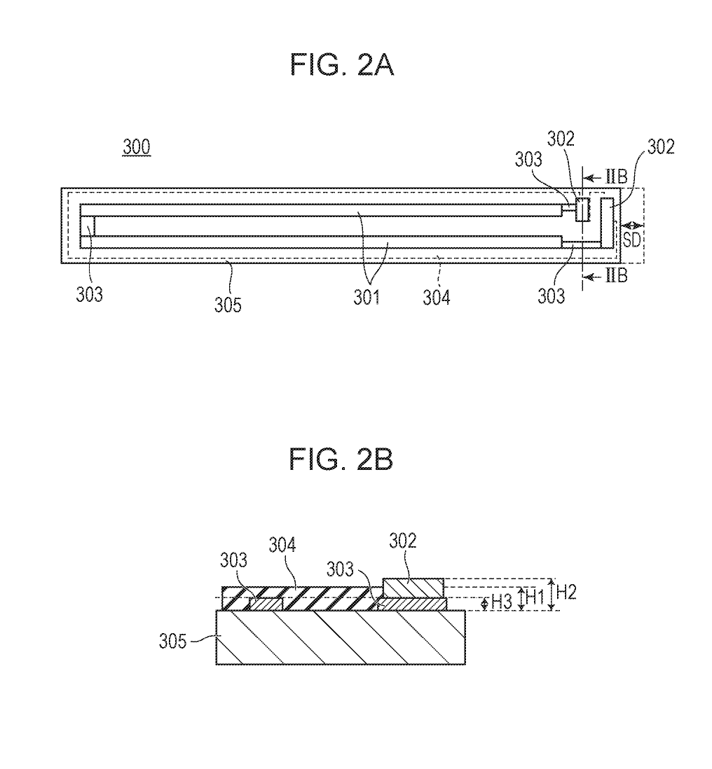

A configuration of the heater 300 of a first exemplary embodiment will be described next with reference to FIGS. 2A and 2B. FIG. 2A is a plan view of the heater, and FIG. 2B is a cross-sectional view taken along line IIB-IIB in FIG. 2A. As illustrated in FIG. 2A, a heating element 301 is provided on a ceramic substrate 305 in the longitudinal direction of the substrate 305. Electric power is supplied to the heating element 301 from a commercial alternating current power source through electrodes 302 and conductors 303. Furthermore, the heater 300 is protected by an insulating layer 304 formed of a material such as glass. As described above, the heater 300 includes the insulating substrate, the heating element formed on the substrate, the electrodes connected to the heating element and to which the electrical contact members for supplying electric power to the heating element are connected, and the insulating layer that covers the heating element.

The insulating layer 304 covers the heater 300 except for the electrodes 302, that is, the insulating layer 304 covers the conductors 303 and the heating element 301. In FIG. 2B, H1 indicates a height from a surface of the substrate 305 to a surface of the insulating layer 304, H2 indicates a height from the surface of the substrate 305 to a surface of each electrode 302, and H3 indicates a height from the surface of the substrate 305 to a surface of each conductor 303. As described above, in the heater 300 of the present exemplary embodiment, the surfaces of the electrodes 302 protrude from the surface of the insulating layer 304. Owing to such a configuration, when the electrical contact members are abutted against the electrodes 302, the insulating layer 304 is not in the way. Accordingly, even when the widths (the widths in the longitudinal direction of the heater) of the electrodes 302 are small, the electrical contact members can be reliably abutted against the electrodes 302. Furthermore, since the width of the electrodes 302 can be made small, advantageously, the length of the substrate 305 can be made short. In FIG. 2A, SD indicates the area in which the size has been reduced. Note that in the present exemplary embodiment, the electrodes 302 are formed on the conductors 303, and silver is employed in both the conductors 303 and the electrodes 302.

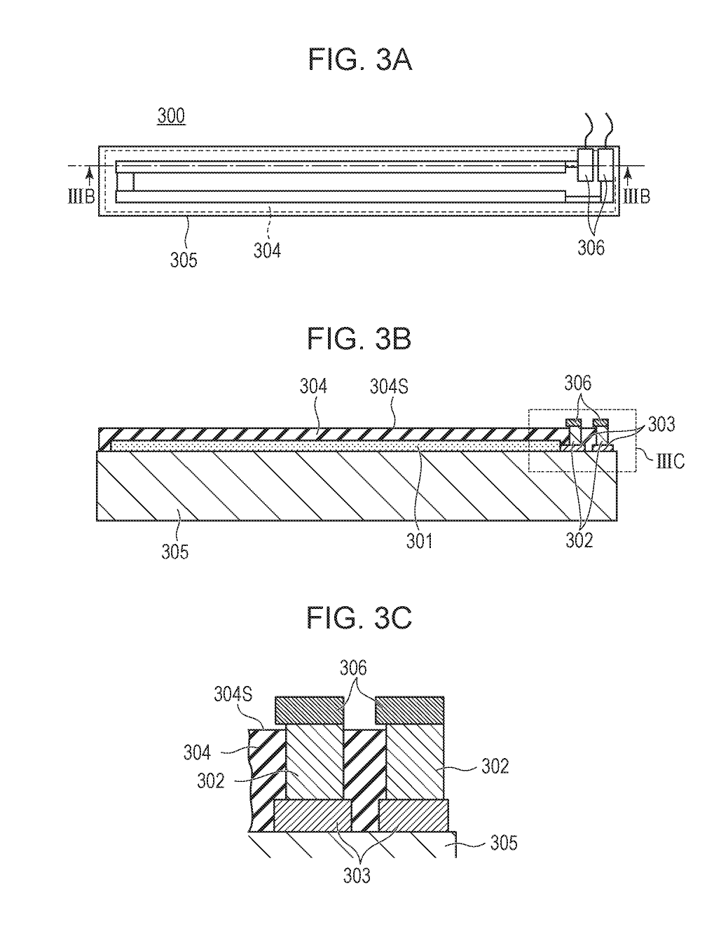

FIGS. 3A to 3C are diagrams illustrating the relationship between the electrodes 302 and electrical contact members 306 when the heater of the present exemplary embodiment is used. FIG. 3A is a plan view of the heater, and FIG. 3B is a cross-sectional view taken along line IIIB-IIIB in FIG. 3A. Furthermore, FIG. 3C is an enlarged view of the portion surrounded by a broken line IIIC in FIG. 3B.

As illustrated in FIGS. 3A to 3C, by connecting the electrical contact members 306 to the electrodes 302, electric power can be supplied to the heating element 301 from a commercial alternating current power source. As illustrated in FIGS. 3B and 3C, in the heater 300 of the present exemplary embodiment, the electrical contact members 306 can be disposed so as to overlap the insulating layer 304. In other words, since the surfaces of the electrodes 302 are positioned higher than a surface 304S of the insulating layer 304, even if the electrical contact members 306 are made to overlap the insulating layer 304, by compressing the electrical contact members 306 to the electrodes 302, a predetermined contact pressure can be obtained in a reliable manner.

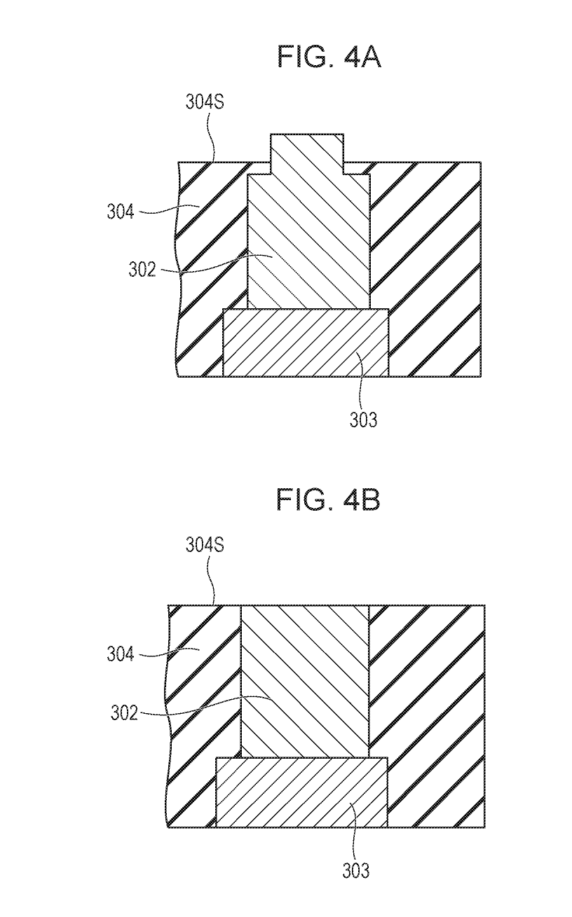

In the present exemplary embodiment, a configuration in which the surfaces of the electrodes 302 are protruded with respect to the surface 304S has been described; however, as illustrated in FIG. 4B, the heights may be the same. Furthermore, as illustrated in FIG. 4A, a portion of the electrode 302 may be protruded with respect to the surface 304S of the insulating layer 304.

In the present exemplary embodiment, while the electrodes 302 are constituted by a single material, the electrodes 302 may be constituted by two or more materials. The material used in the electrodes 302 is desirably metal having excellent corrosion resistance or conductivity such as, for example, Ag, Ni, Cu, Au, Pt, Al, Sn, or an alloy of the above. Furthermore, the method of forming the electrodes 302 is not limited to any method, such as plating, bonding, welding, thermal spraying, and printing. Furthermore, the electrodes 302 do not necessarily have to be fixed to the conductors 303. Using the pressure of the electrical contact members 306, the electrodes 302 may be held between the electrical contact members 306 and the conductors 303 (alternatively, between the electrical contact members 306 and the substrate 305).

As described above, in the heater of the present exemplary embodiment, in a direction orthogonal to the surface of the substrate, the surfaces of the electrodes are flush with the surface of the insulating layer or protrude with respect to the surface of the insulating layer. With the above configuration, the areas of the electrodes can be smaller and the heater can be reduced in size and cost.

### Second Exemplary Embodiment

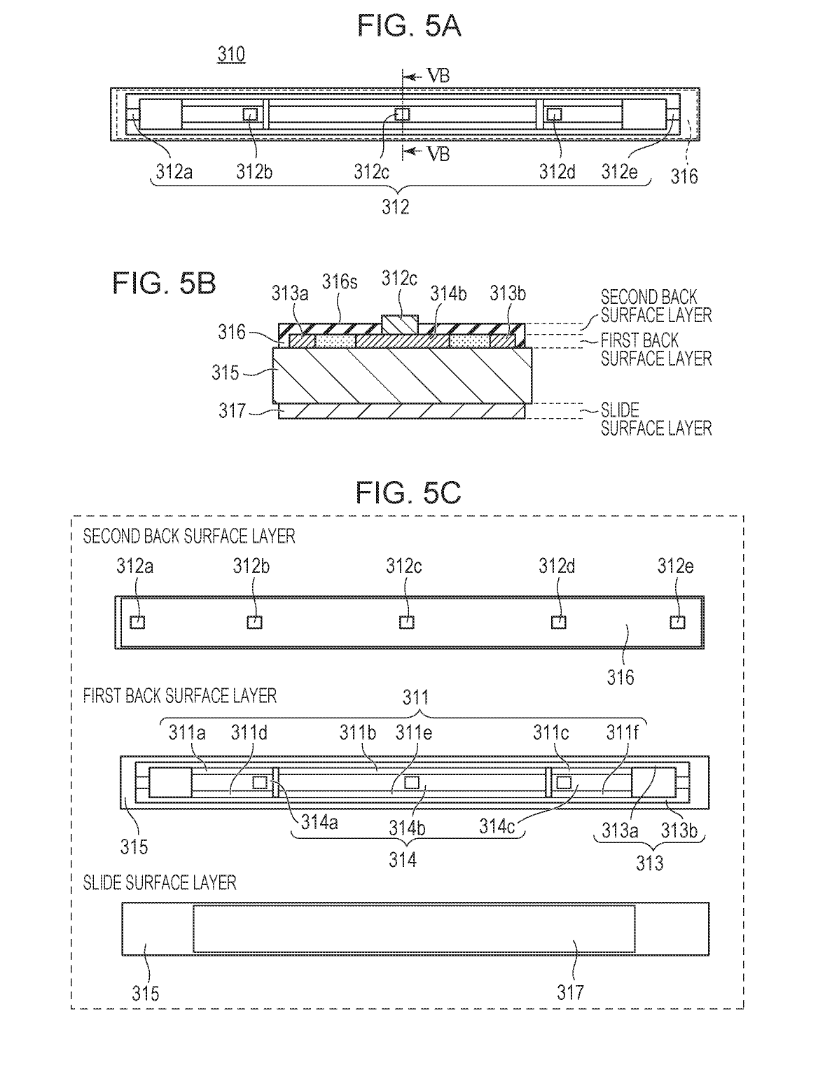

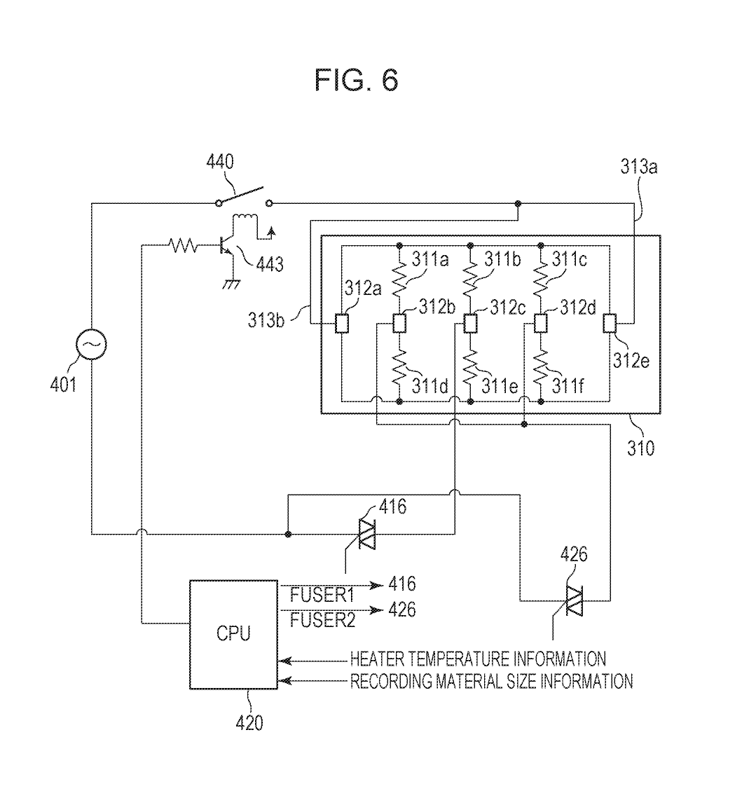

FIGS. 5A to 5C are diagrams illustrating a configuration of a heater according to a second exemplary embodiment. Compared with the heater 300 of the first exemplary embodiment, the configurations of the heating element 301, the electrodes 302, and the conductors 303 are different in a heater 310 illustrated in FIGS. 5A to 5C. FIG. 5A is a diagram illustrating a back surface (a surface that is on the opposite side with respect to the surface coming in contact with the film) of the heater 310, FIG. 5B is a cross-sectional view taken along line VB-VB in FIG. 5A, FIG. 5C is a diagram illustrating each layer of the heater 310. FIG. 6 is a diagram of a drive circuit of the heater 310.

In a first back surface layer of the heater 310, a first conductor 313 is provided on a substrate 315 so as to extend in a longitudinal direction of the heater 310. Furthermore, a second conductor 314 is provided on the substrate 315 at a position that is different from the position of the first conductor 313 in the short direction of the heater 310 so as to extend in the longitudinal direction of the heater 310. The first conductor 313 is separated into a conductor 313a that is disposed on the upstream side in the conveyance direction of the recording material P, and a conductor 313b that is disposed on the downstream side. The second conductor 314 is divided into three pieces (314a, 314b, and 314c) each extending in the longitudinal direction of the heater 310. Furthermore, the heater 310 is provided with a heating element 311 between the first conductor 313 and the second conductor 314. The heating element 311 generates heat by having electric power supplied thereto through the first conductor 313 and the second conductor 314. An insulating layer (glass layer) 316 that covers the heating element 311, the conductor 313, and the conductor 314 is provided in a second back surface layer of the heater 310. Furthermore, a surface protection layer 317 that has a sliding characteristic and that is formed by coating glass, polyimide, or the like is provided in a slide surface layer of the heater 310.

Referring to FIG. 5C, details of each layer of the heater 310 will be described. In the first back surface layer, the heater 310 includes three sets of heating blocks in the longitudinal direction of the heater 310, each set including the first conductor 313, the second conductor 314, and the heating element 311. A first heating block includes the first conductor 313, heating elements 311a and 311d, and the second conductor 314a. A second heating block includes the first conductor 313, heating elements 311b and 311e, and the second conductor 314b. A third heating block includes the first conductor 313, heating elements 311c and 311f, and the second conductor 314c.

The supply of electric power to the second heating block from an alternating current power source 401 is controlled by controlling a triac 416. Furthermore, the supply of electric power to the first and third heating blocks from the alternating current power source 401 is controlled by controlling a triac 426. The triac 416 is driven in accordance with a FUSER 1 signal output from a CPU 420. The triac 426 is driven in accordance with a FUSER 2 signal output from the CPU 420. The CPU 420 outputs the FUSER 1 signal and the FUSER 2 signal according to heater temperature information and recording material size information. Note that reference numeral 440 is a relay and is turned on and off with the control of the CPU 420 controlling a relay drive circuit 443.

The heater 310 includes a plurality of electrodes. Electrodes 312a to 312e are connected to electrical contact members for supplying electric power to the heating elements 311 from the alternating current power source 401. The electrode 312b is an electrode for supplying electric power to the first heating block through the conductor 314a. The electrode 312c is an electrode for supplying electric power to the second heating block through the conductor 314b. The electrode 312d is an electrode for supplying electric power to the third heating block through the conductor 314c. The electrodes 312a and 312e connected to the electrical contact members are electrodes for supplying electric power to the three heating blocks through the conductors 313a and 313b.

As illustrated in FIG. 5B, in the heater 310 of the present exemplary embodiment, the electrode 312c is protruded with respect to a surface 316S of the insulating layer 316. While FIG. 5B is a cross-section of the portion of the electrode 312c, the other four electrodes 312a, 312b, 312d, and 312e other than the electrode 312c are protruded with respect to the surface 316S of the insulating layer 316 in a similar manner to the electrode 312c. Accordingly, even when the electrical contact members are disposed so as to overlap the insulating layer 316, by compressing the electrical contact members towards the electrodes 312, a desired contact pressure can be obtained. Note that in the configuration of the heater of the present exemplary embodiment in which the electrodes are disposed in the longitudinal direction of the heater where the heating elements are provided, if the surfaces of the electrodes are recessed with respect to the surface of the insulating layer, disadvantageously, the area of the electrodes need to be made large. Accordingly, the heater becomes disadvantageously large. Conversely, in the heater of the present exemplary embodiment, since the areas of the electrodes can be minimized, the heater can be prevented from becoming large. In the present exemplary embodiment, the heating block is divided into three pieces; however, the number in which the heating block is divided is not limited to three. The present disclosure can be applied to configurations in which the heating block is divided into more number of pieces. The configuration of the present exemplary embodiment becomes more effective as the number of division increases.

In the present exemplary embodiment, while a configuration in which the front surfaces of the electrodes 312 are protruded with respect to the surface of the insulating layer 316 has been described, the configuration illustrated in FIG. 4B may be adopted. Furthermore, the surfaces of all the electrodes do not have to be flush with the surface of the insulating layer or protruded with respect to the insulating layer, and it is only sufficient that the surface of at least one electrode layer is flush with the surface of the insulating layer or protruded with respect to the surface of the insulating layer. In the case of the heater of the second exemplary embodiment, it is desirable that the surfaces of at least the three electrodes 312b, 312c, and 312d that are in the area in which the heating elements are disposed in the longitudinal direction of the heater are flush with the surface of the insulating layer or protruded with respect to the surface of the insulating layer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-152145, filed Jul. 31, 2015, which is hereby incorporated by reference herein in its entirety.

What is claimed is:

1. A heater used in an image heating apparatus that heats an image formed on a recording material, the heater comprising:
an insulating substrate;
a heating element formed on the substrate;
an electrode connected to the heating element, an electrical contact member that supplies electric power to the heating element being connected to the electrode; and
an insulating layer covering the heating element,
wherein in a direction orthogonal to a surface of the substrate, a surface of the electrode is protruded with respect to a surface of the insulating layer.

2. An image heating apparatus that heats an image formed on a recording material, the image heating apparatus comprising:
a heater,
wherein the heater includes
an insulating substrate,
a heating element formed on the substrate,
an electrode connected to the heating element, an electrical contact member that supplies electric power to the heating element being connected to the electrode, and
an insulating layer covering the heating element,
wherein in a direction orthogonal to a surface of the substrate, a surface of the electrode is protruded with respect to a surface of the insulating layer.

3. The image heating apparatus according to claim 2, further comprising:
a cylindrical film that rotates while in contact with the heater.

4. The image heating apparatus according to claim 3, further comprising:
a roller that forms a nip portion together with the heater with the film in between, the nip portion transporting the recording material.

5. A heater used in an image heating apparatus that heats an image formed on a recording material, the heater comprising:
an insulating substrate;
a heating element formed on the substrate;
an electrode connected to the heating element, an electrical contact member that supplies electric power to the heating element being connected to the electrode; and
an insulating layer covering the heating element,
wherein, in the longitudinal direction of the heater, the electrode is provided within an area where the heating element is provided, and
wherein in a direction orthogonal to a surface of the substrate, a surface of the electrode is flush with a surface of the insulating layer or is protruded with respect to the surface of the insulating layer.

6. The heater according to claim 5,
wherein the heating element is divided into a plurality of pieces.

7. The heater according to claim 6,
wherein the plurality of pieces of the divided heating element are capable of being controlled independently.

8. An image heating apparatus that heats an image formed on a recording material, the image heating apparatus comprising:
a heater,
wherein the heater includes
an insulating substrate,
a heating element formed on the substrate,
an electrode connected to the heating element, an electrical contact member that supplies electric power to the heating element being connected to the electrode, and
an insulating layer covering the heating element,
wherein, in the longitudinal direction of the heater, the electrode is provided within an area where the heating element is provided, and
wherein in a direction orthogonal to a surface of the substrate, a surface of the electrode is flush with a surface of the insulating layer or is protruded with respect to the surface of the insulating layer.

9. The image heating apparatus according to claim 8,
wherein the heating element is divided into a plurality of pieces.

10. The image heating apparatus according to claim 9,
wherein the plurality of pieces of the divided heating element are capable of being controlled independently.

11. The image heating apparatus according to claim 8, further comprising:
a cylindrical film that rotates while in contact with the heater.

12. The image heating apparatus according to claim 11, further comprising:
a roller that forms a nip portion together with the heater with the film in between, the nip portion transporting the recording material.
